(19) United States
(12) Patent Application Publication
(10) Pub. No.: US 2026/0235435 A1
(43) Pub. Date: Aug. 13, 2026

(54) EQUIPMENT LOCATION ANALYSIS DEVICE AND EQUIPMENT LOCATION ANALYSIS METHOD

(71) Applicant: NTT, Inc., Tokyo (JP)

(72) Inventors: Hiroshi TAKAHASHI, Musashino-shi, Tokyo (JP); Yoshifumi WAKISAKA, Musashino-shi, Tokyo (JP); Yusuke KOSHIKIYA, Musashino-shi, Tokyo (JP); Daisuke IIDA, Musashino-shi, Tokyo (JP)

(73) Assignee: NTT, Inc., Tokyo (JP)

(21) Appl. No.: 19/154,291

(22) PCT Filed: Feb. 9, 2023
(86) PCT No.: PCT/JP2023/004373

§ 371 Date: Aug. 6, 2025

(51) Int. Cl. G01H 9/00; G01D 5/353

(52) U.S. Cl. CPC G01H 9/004; G01D 5/35361

(57) ABSTRACT

The present disclosure is a facility position analysis device including: an optical signal feature extraction means for generating a feature point distribution waveform expressing a distribution of feature points in a longitudinal direction of an optical fiber under measurement, by extracting the feature points in a vibration distribution waveform measured by an optical fiber line vibration measuring device installed at one end of the optical fiber under measurement; a facility information waveform generation means for generating a facility information waveform expressing a distribution of facilities, connected to the optical fiber under measurement in a longitudinal direction of the optical fiber under measurement, based on interval information between the facilities; and a feature amount comparison means for relating facility information with the vibration distribution waveform, by comparing the feature point distribution waveform with the facility information waveform.

### TECHNICAL FIELD

The present disclosure relates to a distributed acoustic sensing technique.

### BACKGROUND ART

Non Patent Literature 1 discloses a method, called distributed acoustic sensing (DAS) capable of measuring physical vibration around an optical fiber under measurement by detecting a phase change deriving from a minute change in optical fiber length caused by vibration propagated to the optical fiber.

Non Patent Literature 2 discloses that, in executing a method of observing a temporal change of phase in scattered light from each point of an optical fiber, a phase linearly changes in response to an optical path length change of an optical fiber caused by vibration. Non Patent Literature 2 further discloses that, by reason of rates of change in phase at separate points of the optical fiber, which can be considered to be approximately the same with respect to the longitudinal direction thereof, the vibration can be quantitatively measured and thus a vibration waveform applied to an optical fiber under measurement can be faithfully reproduced.

Non Patent Literature 3 and Patent Literature 1 disclose a technique of calculating a phase on the basis of scattered light having each wavelength from an optical fiber (optical fiber line) into which wavelength-multiplexed pulsed light enters in advance, thereby measuring physical vibration propagated to the optical fiber. According to the techniques of Non Patent Literature 3 and Patent Literature 1, scattered light vectors representing scattered light having different frequencies are targeted, frequency division multiplexing (FDM) for averaging scattered light vectors having the different frequencies is performed, and then a frequency average vector is generated. Then, the vibration transmitted to the optical fiber is measured on the basis of a phase of the frequency average vector. Deterioration, in sensitivity, caused by interference between scattered light beams within a pulse width (duration of pulsed light) is controlled by the FDM, thereby improving measurement accuracy with regard to the vibration propagated to the optical fiber.

In addition, as a method of inspecting a spot, to which inspector goes, Patent Literature 2 discloses a method of collating a hammer impact with a waveform acquired by an optical fiber line vibration measuring device. In this method, the optical fiber line vibration measuring device is installed at one end of the existing optical fiber to acquire a vibration distribution waveform. In addition, on the spot, for example, the lid of a manhole is struck with a hammer to apply vibration to the manhole. By observing the vibration, applied to the manhole, with the optical fiber line vibration measuring device, the collation enables the inspector to determine which position is the position of the manhole, where the impact is applied, and to identify a facility position. However, since this method requires the inspector to go to the spot, occupy the road or the like, and apply impact, identifying the facility position takes a huge amount of time.

### CITATION LIST

### Patent Literature

Patent Literature 1: JP 2020-169904 A (JP 7111045 B2, NTT)
Patent Literature 2: JP 2020-052030 A (JP 6974747 B2, NTT)

### Non Patent Literature

Non Patent Literature 1: Ali. Masoudi, T. P. Newson, “Contributed Review: Distributed optical fibre dynamic strain sensing” Review of Scientific Instruments, vol. 87, p. 011501(2016)
Non Patent Literature 2: Ken'ichi Nishiguchi, Li Che-Hsien, Artur Guzik, Mitsunori Yokoyama, Kinzo Kishida, “Fabrication of Fiber-Optic Distributed Acoustic Sensor and Its Signal Processing”, IEICE Technical Report, 115(202), pp. 29-34(2015)
Non Patent Literature 3: Yoshifumi Wakisaka, Daisuke Iida, Hiroyuki Oshida, and Nazuki Honda, “Fading Suppression of φ-OTDR With the New Signal Processing Methodology of Complex Vectors Across Time and Frequency Domains,” J. Lightwave Technology, Vol. 39, No. 13, pp. 4279-4293 (2021)

### SUMMARY OF INVENTION

### Technical Problem

The inspector needs to accurately find which position information of the actual facility on the vibration waveform acquired by an optical fiber line vibration measuring device. However, in relating the information, acquired by the optical fiber line vibration measuring device, with the facility information at each point of an optical fiber, there is no means for accurately relating the distance of the vibration waveform with the facility information.

Therefore, an object of the present disclosure is to accurately relate the distance of the vibration waveform with the facility information.

### Solution to Problem

In order to achieve the above object, the present disclosure enables accurate relation of facility information with a measured vibration waveform by comparing a facility information waveform obtained from the facility information, with a feature point distribution waveform extracted from a feature amount of a measured vibration distribution waveform.

A facility position analysis device of the present disclosure includes:
an optical signal feature extraction means for generating a feature point distribution waveform expressing a distribution of a feature points in a longitudinal direction of an optical fiber under measurement, by extracting the feature points in a vibration distribution waveform measured by an optical fiber line vibration measuring device installed at one end of the optical fiber under measurement;
a facility information waveform generation means for generating a facility information waveform expressing a distribution of facilities, connected to the optical fiber under measurement in the longitudinal direction of the optical fiber under measurement, based on interval information between the facilities; and
a feature amount comparison means for relating facility information with the vibration distribution waveform, by comparing the feature point distribution waveform with the facility information waveform.

A facility position analysis method of the present disclosure includes:
generating, by an optical signal feature extraction means, a feature point distribution waveform expressing a distribution of feature points in a longitudinal direction of an optical fiber under measurement, by extracting the feature points in a vibration distribution waveform measured by an optical fiber line vibration measuring device installed at one end of the optical fiber under measurement;
generating, by a facility information waveform generation means, a facility information waveform expressing a distribution of facilities, connected the optical fiber under measurement in the longitudinal direction of the optical fiber under measurement, based on interval information between the facilities; and
relating, by a feature amount comparison means, facility information with the vibration distribution waveform, by comparing the feature point distribution waveform with the facility information waveform.

The optical signal feature extraction means may extract the feature points by detecting feature amounts by which a vibration waveform changes at facility positions. The feature amounts by which the vibration waveform changes may be a feature amount depending a change from the optical fiber under measurement, laid in a pipeline to the optical fiber under measurement, laid in a manhole.

The facility information waveform generation means may output a digital waveform having
a freely-selected value given to positions of the facilities in the longitudinal direction of the optical fiber under measurement, and
a value, smaller than the freely-selected value, given to a point other than the positions of the facilities in the longitudinal direction of the optical fiber under measurement, and
a data score between the facilities may be proportional to a data score corresponding to distance of the vibration distribution waveform.

The feature amount comparison means may calculate a cross-correlation between the feature point distribution waveform and the facility information waveform, and relate the facility information of the facilities with the feature points having a high cross-correlation with the positions of the facilities.

The device of the present invention can also be implemented by a computer and a program, and the program can be recorded in a recording medium or provided through a network. A program of the present disclosure is a program for directing a computer to function as each means included in the device according to the present disclosure and is a program for directing a computer to perform each step included in a method performed by the device according to the present disclosure.

Note that, the above disclosures can be combined in any possible manner.

### Advantageous Effects of Invention

The present disclosure enables accurate relation of facility information with a measured vibration distribution waveform.

### BRIEF DESCRIPTION OF DRAWINGS

FIG. 1 illustrates a system configuration example of the present disclosure.

FIG. 2 illustrates an example of a measurement result by an optical fiber line testing device.

FIG. 3 illustrates an example of facility information.

FIG. 4 is an explanatory diagram of an operation of a facility information waveform generation means.

FIG. 5 is an explanatory diagram of an operation of an optical signal feature extraction means.

FIG. 6 is an explanatory diagram of an operation of a feature amount comparison means.

FIG. 7 illustrates an example of relation between a vibration distribution waveform and a facility.

### DESCRIPTION OF EMBODIMENTS

Hereinafter, embodiments of the present disclosure will be described in detail with reference to the drawings. Note that, the present disclosure is not limited to the embodiments described below. These embodiments are merely examples, and the present disclosure can be implemented in a form with various modifications and improvements based on the knowledge of those skilled in the art. Note that, components indicated by the same reference signs in the present specification and the drawings are the same components.

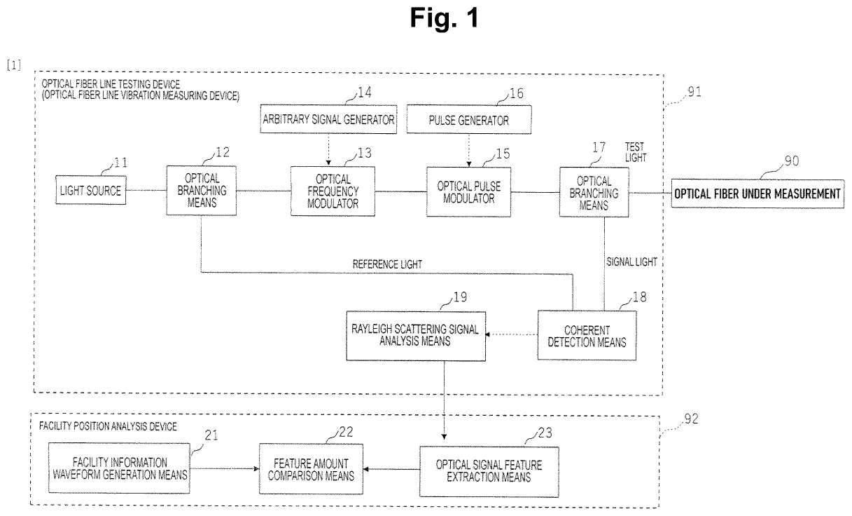

FIG. 1 illustrates a system configuration example of the present disclosure. A system of the present disclosure includes an optical fiber line testing device 91 and a facility position analysis device 92. The optical fiber line testing device 91 is a distributed acoustic sensing device that functions as an optical fiber line vibration measuring device connected to one end of an optical fiber under measurement 90 and that is capable of measuring a distribution in the longitudinal direction of the vibration propagated to the optical fiber under measurement 90. The optical fiber line testing device 91 according to the present embodiment acquires a vibration distribution waveform by measuring a phase change deriving from a minute change in optical fiber length caused by vibration propagated to the optical fiber under measurement 90.

The optical fiber line testing device 91 includes, for example, a light source 11, an optical branching means 12, an optical frequency modulator 13, an arbitrary signal generator 14, an optical pulse modulator 15, a pulse generator 16, an optical branching means 17, a coherent detection means 18, and a Rayleigh scattering signal analysis means 19.

The optical branching means 12 splits the light from the light source 11 into two outputs.

The optical frequency modulator 13 modulates one of the split light outputs at a modulation frequency corresponding to the signal from the arbitrary signal generator 14.

The optical pulse modulator 15 modulates the light, modulated by the optical frequency modulator 13, to provide an optical pulse corresponding to the pulse signal from the pulse generator 16.

The optical branching means 17 outputs the optical pulse from the optical pulse modulator 15 to the optical fiber under measurement 90, and outputs the backscattered light (signal light) from the optical fiber under measurement 90 to the coherent detection means 18.

The coherent detection means 18 coherently detects the signal light from the optical fiber under measurement 90.

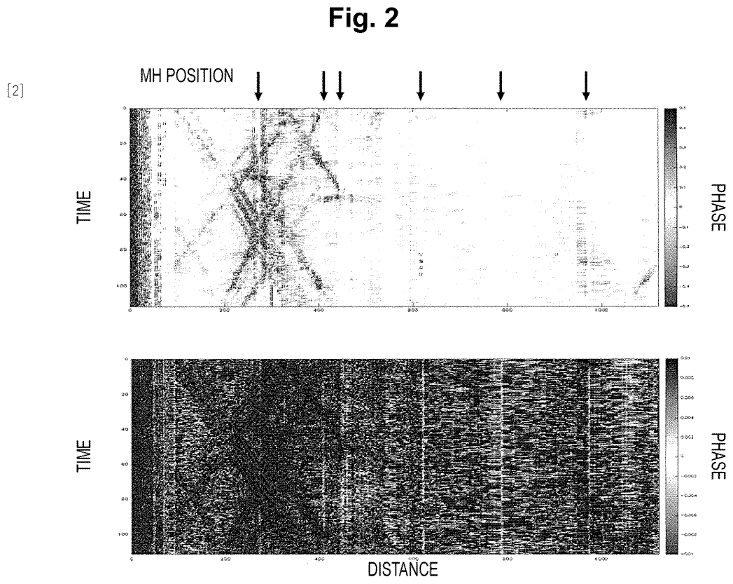

The Rayleigh scattering signal analysis means 19 analyzes the signal waveform obtained by the coherent detection of the coherent detection means 18. For example, a phase change at the frequency, corresponding to the distance from the one end of the optical fiber under measurement 90, is analyzed. As a result, the optical fiber line testing device 91 can measure a phase change deriving from a minute change in optical fiber length caused by vibration propagated to the optical fiber under measurement 90 as illustrated in FIG. 2. In the present disclosure, the optical waveform in which a vibration distribution appears as illustrated in FIG. 2 is referred to as a vibration distribution waveform.

In the vibration distribution waveforms of FIGS. 2(a) and 2(b), the horizontal axis indicates distance, the vertical axis indicates time, and the shading indicates a phase. FIG. 2 (a) illustrates an example in which the phase display range is 0.5 to −0.5, and FIG. 2 (b) illustrates an example in which the phase display range is 0.1 to −0.1.

The arrows toward the horizontal axis indicate the distance at which manholes are installed. Since an optical cable hardly vibrates at the distance where the manhole is present, the waveforms can show that the vibration propagation through the optical fiber under measurement 90 in the optical cable is discontinuous. As described above, a feature such as discontinuous vibration propagation appears at a facility change point. Therefore, in the present disclosure, by extracting feature points at which a vibration waveform of an optical signal changes, facility information is accurately related with a measured vibration distribution waveform.

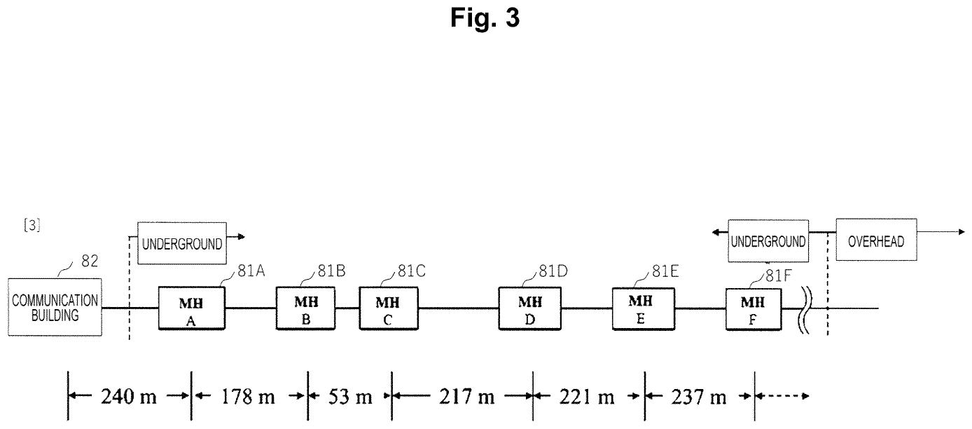

FIG. 3 illustrates an example of facility information according to the present embodiment. The facility information is information on facilities connected to the optical fiber under measurement 90, and includes identification information on each facility and interval information between facilities. In the present embodiment, as an example of the facility information, an example is illustrated in which the optical fiber under measurement 90, connected to a communication building 82, is sequentially connected to manholes 81A to 81F, and intervals therebetween are 240 m, 178 m, 53 m, 217 m, 221 m, and 237 m.

The facility position analysis device 92 is a device that relates the vibration waveform measured by the optical fiber line testing device 91 with facility information, and includes, for example, a facility information waveform generation means 21, a feature amount comparison means 22, and an optical signal feature extraction means 23. The facility position analysis device 92 can also be achieved by a computer and a program, and the program can be recorded in a recording medium or provided through a network.

The facility information waveform generation means 21 generates a facility information waveform for feature amount comparison, using the facility information stored in a facility information database. The facility information waveform expresses the distribution of facilities in the longitudinal direction of the optical fiber under measurement 90. For example, the facility information waveform generation means 21 acquires the positions of the facilities from the facility information database, outputs a digital waveform having a freely-selected value given to the positions of the facilities in the longitudinal direction of the optical fiber under measurement 90, and a value, smaller than the freely-selected value, given to a point other than the positions of the facilities in the longitudinal direction of the optical fiber under measurement 90. A data score between the facilities is proportional to a data score corresponding to distance of the vibration distribution waveform.

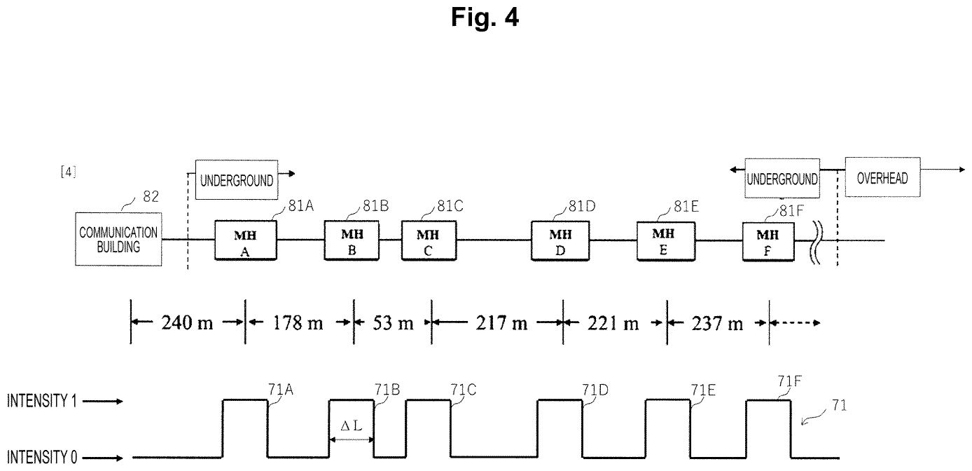

FIG. 4 illustrates an example of the facility information waveform. For example, a facility information waveform 71 is a digital waveform in which a value “1” is given to the positions of the manholes 81A to 81F in the longitudinal direction of the optical fiber under measurement 90, and a value “0”, smaller than the value “1”, is given at points other than the manholes 81A to 81F in the longitudinal direction of the optical fiber under measurement 90. The width of the intensity 0 is a width proportional to the interval between facilities of the facility information, and in the present embodiment, the width is a width proportional to each interval between the manholes 81A to 81F connected by the optical fiber under measurement 90. As a result, the facility information waveform 71 having peaks 71A to 71F is generated.

Here, a width ΔL of the intensity 1 is freely-selected, and is, for example, a width calculated using a spatial resolution Δz1 of the optical fiber line testing device 91 and a difference Δz2 between the actual length and the line length of the optical fiber under measurement 90. The width ΔL of the intensity 1 can be expressed by, for example, the following expression.

$$Δ L = Δ z 1 + Δ z 2$$

Additionally, the interval information that can be acquired by the optical fiber line testing device 91 is the delay time depending on the optical path length in the optical fiber under measurement 90, whereas the facility information brings about a distance difference caused by dealing with the length of the optical cable. Since an optical fiber is twisted into an S type or an SZ type in the optical cable, there is a difference between the optical cable length and the optical path length. In addition, when the group refractive index of the optical fiber under measurement 90 is not accurate, a difference also occurs between the length of the optical fiber under measurement 90 and the interval information acquired by the optical fiber line testing device 91. Therefore, Δz2 may be set in consideration of the above difference.

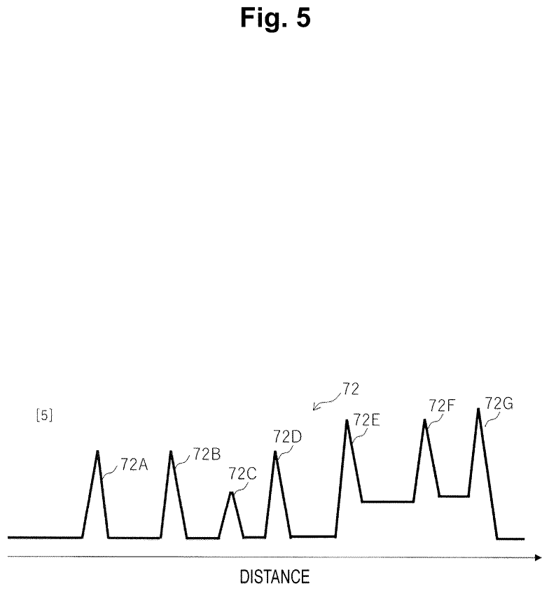

The optical signal feature extraction means 23 extracts feature points in the vibration, measured by the optical fiber line testing device 91, by detecting feature amounts by which a vibration waveform changes at facility positions. Here, in the present disclosure, a feature point extracted by the optical signal feature extraction means 23 has a feature amount depending on a change from the optical fiber under measurement 90, laid in a pipeline, to the optical fiber under measurement 90, laid in a facility such as a manhole. For example, the optical signal feature extraction means 23 calculates the feature amounts by calculating the reciprocal of the absolute value of the phase at each distance. As a result, feature points 72A to 72G, which are discontinuities caused by vibration propagation attenuated by the connection with the manholes 81A to 81F, and the feature amounts at the respective feature points are extracted, and a feature point distribution waveform 72 expressing the distribution of the feature points 72A to 72G in the longitudinal direction of the optical fiber under measurement 90 as illustrated in FIG. 5 can be calculated.

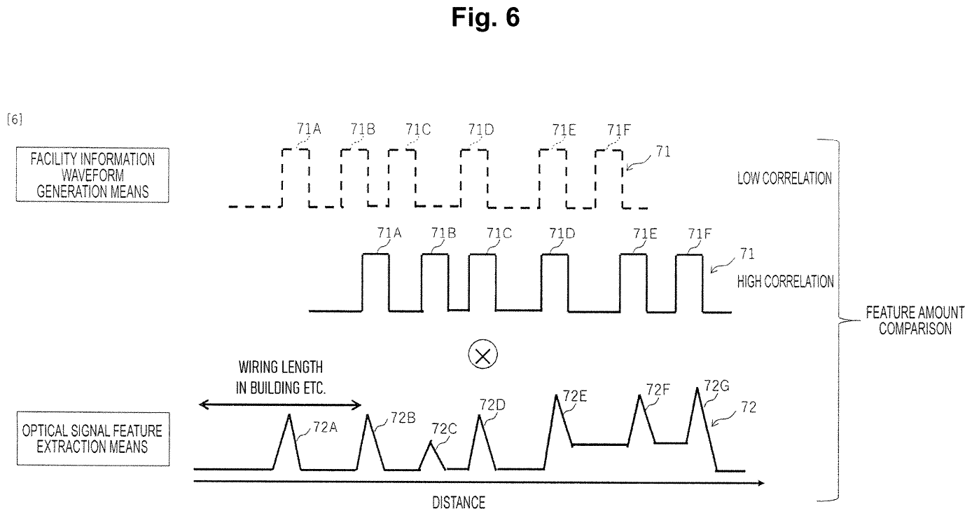

As illustrated in FIG. 6, the feature amount comparison means 22 compares the distance distribution of “1” in the facility information waveform 71 with the distance distribution of the feature points in the feature point distribution waveform 72. For example, a cross-correlation between the facility information waveform 71 and the feature point distribution waveform 72 is calculated. This enables determination of the feature points concordant with the distance distribution of the facilities in the feature point distribution waveform 72.

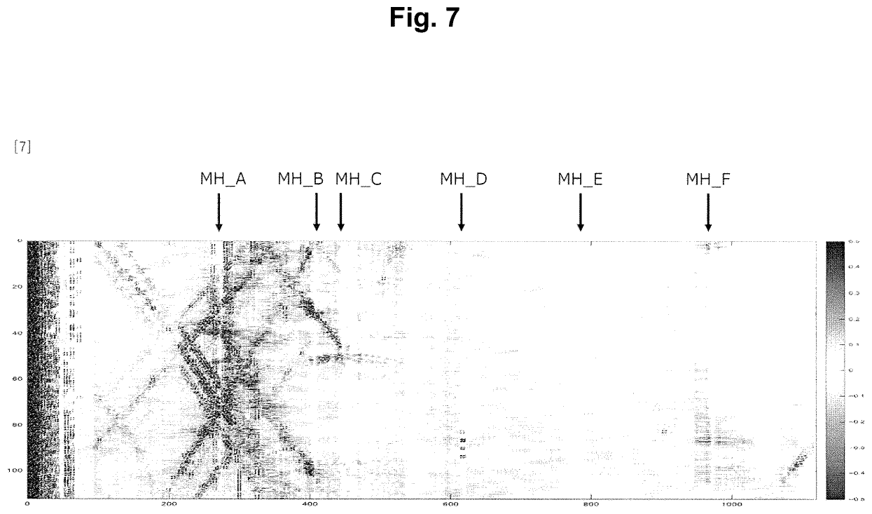

As illustrated in FIG. 7, the feature amount comparison means 22 may display the facility information that is related with the vibration distribution waveform. For example, in the present embodiment, the feature points 72B to 72G in the feature point distribution waveform 72 have a high correlation with the facility information waveform 71. In this regard, the feature amount comparison means 22 relates the feature points 72B to 72G with different facilities in the facility information waveform 71. For example, the feature point 72B concordant with the peak 71A is related with the manhole 81A. The feature point 72G concordant with the peak 71F is related with the manhole 81F. The same applies to the other feature points 72C to 72F. As a result, the feature amount comparison means 22 can accurately relate facility information with a measured vibration distribution waveform.

### REFERENCE SIGNS LIST

11 Light source
12 Optical branching means
13 Optical frequency modulator
14 Arbitrary signal generator
15 Optical pulse modulator
16 Pulse generator
17 Optical branching means
18 Coherent detection means
19 Rayleigh scattering signal analysis means
21 Facility information waveform generation means
22 Feature amount comparison means
23 Optical signal feature extraction means
91 Optical fiber line testing device
92 Facility position analysis device

1. A facility position analysis device comprising:
an optical signal feature extraction means for generating a feature point distribution waveform expressing a distribution of feature points in a longitudinal direction of an optical fiber under measurement, by extracting the feature points in a vibration distribution waveform measured by an optical fiber line vibration measuring device installed at one end of the optical fiber under measurement;
a facility information waveform generation means for generating a facility information waveform expressing a distribution of facilities, connected to the optical fiber under measurement in the longitudinal direction of the optical fiber under measurement, based on interval information between the facilities; and
a feature amount comparison means for relating facility information with the vibration distribution waveform, by comparing the feature point distribution waveform with the facility information waveform.

2. The facility position analysis device according to claim 1, wherein the optical signal feature extraction means extracts the feature points by detecting feature amounts by which a vibration waveform changes at facility positions.

3. The facility position analysis device according to claim 2, wherein the feature amounts by which the vibration waveform changes is a feature amount depending on a change from the optical fiber under measurement, laid in a pipeline, to the optical fiber under measurement, laid in a manhole.

4. The facility position analysis device according to claim 1, wherein the facility information waveform generation means outputs a digital waveform having
a freely-selected value given to positions of the facilities in the longitudinal direction of the optical fiber under measurement, and
a value, smaller than the freely-selected value, given to a point other than the positions of the facilities in the longitudinal direction of the optical fiber under measurement, and
a data score between the facilities is proportional to a data score corresponding to distance of the vibration distribution waveform.

5. The facility position analysis device according to claim 1, wherein the feature amount comparison means calculates a cross-correlation between the feature point distribution waveform and the facility information waveform, and relates the facility information of the facilities with the feature points having a high cross-correlation with the positions of the facilities.

6. A facility position analysis method comprising:
generating, by an optical signal feature extraction means, a feature point distribution waveform expressing a distribution of feature points in a longitudinal direction of an optical fiber under measurement, by extracting the feature points in a vibration distribution waveform measured by an optical fiber line vibration measuring device installed at one end of the optical fiber under measurement;
generating, by a facility information waveform generation means, a facility information waveform expressing a distribution of facilities, connected to the optical fiber under measurement in a longitudinal direction of the optical fiber under measurement, based on interval information between the facilities; and
relating, by a feature amount comparison means, facility information with the vibration distribution waveform, by comparing the feature point distribution waveform with the facility information waveform.

7. A non-transitory storage medium containing a program for directing a computer to function as each means included in the facility position analysis device according to claim 1.
